(19) United States
(12) Patent Application Publication
(10) Pub. No.: US 2026/0282135 A1
(43) Pub. Date: Sep. 17, 2026

(54) Managing Relay Link Bandwidth

(71) Applicant: Google LLC, Mountain View, CA (US)

(72) Inventor: Sunil Kumar, Cupertino, CA (US)

(21) Appl. No.: 19/473,458

(22) PCT Filed: Apr. 5, 2024
(86) PCT No.: PCT/US2024/023257

§ 371 Date: Oct. 7, 2025

Related U.S. Application Data
(60) Provisional application No. 63/495,008, filed on Apr. 7, 2023.

(51) Int. Cl. H04W 76/15; H04W 4/80; H04W 88/04

(52) U.S. Cl. CPC H04W 76/15; H04W 4/80; H04W 88/04

(57) ABSTRACT

Various arrangements for managing a relay link bandwidth over Bluetooth Classic and Bluetooth Low Energy (BLE) are described herein. According to techniques described herein, the Bluetooth bandwidth used by the earbuds for relay Determine Bandwidth Used For Audio Transmissions within traffic between the earbuds is directed at being optimized for the audio use cases by using a dynamic placement scheme and configuring a secondary earbud (e.g., an earbud that does not include an established connection with the AH) to be in the central role on the relay link between the earbuds. In the dynamic placement scheme, instead of reserving a predetermined number of slots for the voice traffic before a predetermined number of slots for the relay traffic, the relay traffic can be dynamically placed/moved after the voice traffic ends if voice traffic doesn't use all the reserved bandwidth and hence, some of the voice traffic's reserved bandwidth could be used for the relay traffic.

### CROSS REFERENCES TO RELATED APPLICATIONS

This Application claims priority to U.S. Provisional Patent Application No. 63/495,008, entitled “Managing Relay Link Bandwidth Use of Bluetooth Devices,” filed on Apr. 7, 2023, the entire disclosure of which is hereby incorporated by reference for all purposes.

### BACKGROUND

Bluetooth technologies, such as Bluetooth basic rate or extended data rate (BR/EDR, which can also be referred to as “Bluetooth Classic”) and Bluetooth Low Energy (BLE) communications can be used by a wide variety of devices. Bluetooth technologies can be used to support different type of “audio use cases” such as telephony (cellular), Voice-Over-IP (VOIP) calls, media playback (e.g., music, game notifications, . . . ), and the like. These audio use cases use Enhanced Synchronous Connection Oriented (eSCO) connection when using Bluetooth Classic technology and Connected Isochronous Stream (CIS) connections when using BLE. In some cases, however, the user may experience a degraded user experience when the available Bluetooth bandwidth is not sufficient to meet the needs of different devices.

### SUMMARY

Various embodiments for managing a relay link bandwidth over Bluetooth Classic and Bluetooth Low Energy (BLE) are described herein. The techniques described include devices, such as earbuds, that configured to use a relay link to transfer data between them. In some examples, the relay link can be used to forward one or more voice/audio packets from one earbud to another earbud. For instance, in the case when one earbud does not receive a packet, the relay link can be used to forward the packet from the earbud that received the packet to the earbud that did not receive the packet from the computing device.

In contrast to a voice/audio link established between an audio host (AH) and a device that has a reserved bandwidth, the relay link does not have reserved bandwidth. The utilized bandwidth for the relay link depends on different factors including if the voice/audio packet needs to be forwarded, and the prevalent link conditions (environment, person's body absorption of radio waves, etc.). Generally, if the link conditions are good then there may not be any need to retransmit a packet, but if the link conditions are poor then a packet may need to be retransmitted.

Accordingly, the reserved and utilized bandwidth for the audio use cases is a function of the reserved and utilized bandwidth of eSCO or CIS connection used for audio (e.g., voice, music, and the like) and the utilized bandwidth of the relay link. As the earbud may perform other activities (for example, scans to connect to other devices, multipoint connection to maintain connection with other devices, virtual assistant, . . . ) concurrently with the audio use cases, optimization of the bandwidth usage of the audio use cases can improve the performance and user experience for the audio and concurrently running activities.

According to techniques described herein, the Bluetooth bandwidth for relay traffic between the earbuds is directed at being optimized for the audio use cases by using a dynamic placement scheme and configuring a secondary earbud (e.g., an earbud that does not include an established connection with the AH) to be in the central role on the relay link between the earbuds. In the dynamic placement scheme, instead of reserving a predetermined number of slots for the voice traffic before a predetermined number of slots for the relay traffic, the relay traffic can be dynamically placed/moved after the voice traffic ends if voice traffic doesn't use all the reserved bandwidth and hence, some of the voice traffic's reserved bandwidth could be used for the relay traffic. the relay traffic can be placed after the voice traffic ends.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for managing Bluetooth bandwidth. The method also includes establishing a Bluetooth audio connection between a first earbud and a computing device, where the Bluetooth audio connection is used by the first earbud to receive audio data for the first earbud and a second earbud. In some examples, the method also includes establishing a relay link to transmit relay traffic between the first earbud and a second earbud, where the relay traffic includes at least a portion of the audio data received by the first earbud. In some examples, the method also includes determining that reserved bandwidth associated with the Bluetooth audio connection remains available within an interval after a transmission of the audio data for the interval. The method also includes using at least a portion of the reserved bandwidth to transmit, using the relay link, the at least the portion of the audio data received by the first earbud to the second earbud. Other embodiments of this aspect include corresponding computer systems, apparatus, and computer programs recorded on one or more computer storage devices, each configured to perform the actions of the methods.

Implementations may include one or more of the following features. The method may include determining that the first earbud designated as a primary earbud is configured in a central role on the relay link; and configuring the second earbud in the central role in place of the first earbud. The method may include determining that the second earbud failed to receive the at least the portion of the audio data received by the first earbud over the Bluetooth audio connection during the interval. Determining that the second earbud failed to receive the at least the portion of the audio data may include receiving, at the first earbud, a request from the second earbud to retransmit the at least the portion of the audio data. Determining that the second earbud failed to receive the at least the portion of the audio data may include sending a query from the first earbud to the second earbud associated with use of the relay link during the interval and receiving, at the first earbud, a response from the second earbud that indicates to use the relay link to transmit the at least the portion of the audio data. The earbud and a second earbud can be true wireless stereo earbuds. The Bluetooth audio connection is a connected isochronous stream (CIS) connection with the computing device. The Bluetooth audio connection is an enhanced synchronous connection oriented (eSCO) connection. Implementations of the described techniques may include hardware, a method or process, or computer software on a computer-accessible medium.

One general aspect includes a wireless earbud system that uses a Bluetooth audio protocol. In some examples, the wireless earbud system also includes a first earbud may include a first wireless interface, a first speaker, a first processing system, and a first microphone. The system also includes a second earbud may include: a second wireless interface, a second speaker, a second processing system, and a second microphone, where the first earbud is configured to: establish a Bluetooth audio connection with a computing device, where the Bluetooth audio connection is used by the first earbud to receive audio data for the first earbud and the second earbud; establish a relay link with the second earbud to transmit relay traffic, where the relay traffic includes at least a portion of the audio data received by the first earbud; determine that reserved bandwidth associated with the Bluetooth audio connection remains available within an interval after a transmission of the audio data for the interval; and use at least a portion of the reserved bandwidth to transmit, using the relay link, the at least the portion of the audio data received by the first earbud to the second earbud. Other embodiments of this aspect include corresponding computer systems, apparatus, and computer programs recorded on one or more computer storage devices, each configured to perform the actions of the methods.

Implementations may include one or more of the following features. The wireless earbud system where the first earbud is further configured to cause the second earbud to be configured in the central role in place of the first earbud. The first earbud is further configured to determine that the second earbud failed to receive the at least the portion of the audio data received by the first earbud over the Bluetooth audio connection during the interval. Determining that the second earbud failed to receive the at least the portion of the audio data may include receiving, at the first earbud, a request from the second earbud to transmit the at least the portion of the audio data. Determining that the second earbud failed to receive the at least the portion of the audio data may include sending a query from the first earbud to the second earbud associated with use of the relay link during the interval and receiving, at the first earbud, a response from the second earbud that indicates to use the relay link to transmit the at least the portion of the audio data. The first earbud and a second earbud are true wireless stereo earbuds. The Bluetooth audio connection is a connected isochronous stream (CIS) connection with the computing device. The Bluetooth audio connection is an enhanced synchronous connection oriented (eSCO) connection. Implementations of the described techniques may include hardware, a method or process, or computer software on a computer-accessible medium.

One general aspect includes a non-transitory computer-readable medium containing computer executable instructions for performing operations. The non-transitory computer-readable medium containing computer executable instructions can include establishing a Bluetooth audio connection between a first earbud and a computing device, where the Bluetooth audio connection is used by the first earbud to receive audio data for the first earbud and a second earbud. In some examples, the instructions also include establishing a relay link to transmit relay traffic between the first earbud and a second earbud, where the relay traffic includes at least a portion of the audio data received by the first earbud. The instructions also include determining that reserved bandwidth associated with the Bluetooth audio connection remains available within an interval after a transmission of the audio data for the interval. The instructions also include using at least a portion of the reserved bandwidth to transmit, using the relay link, the at least the portion of the audio data received by the first earbud to the second earbud. Other embodiments of this aspect include corresponding computer systems, apparatus, and computer programs recorded on one or more computer storage devices, each configured to perform the actions of the methods.

Implementations may include one or more of the following features. The non-transitory computer-readable medium where the computer executable instructions that, when executed by a processor, further cause the processor to determine that the first earbud designated as a primary earbud is configured in a central role on the relay link; and configure the second earbud in the central role in place of the first earbud. The non-transitory computer-readable medium may include determining that the second earbud failed to receive the at least the portion of the audio data received by the first earbud over the Bluetooth audio connection during the interval. Determining that the second earbud failed to receive the at least the portion of the audio data may include receiving, at the first earbud, a request from the second earbud to transmit the at least the portion of the audio data. Implementations of the described techniques may include hardware, a method or process, or computer software on a computer-accessible medium.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a system in which data is transmitted between earbuds, and a computing device according to a dynamic placement mechanism.

FIG. 2 illustrates a static placement of a relay link used to transfer relay traffic.

FIG. 3 shows the bits of an exemplary packet that can be used by the SE to request a packet to be forwarded by the PE.

FIG. 4 shows timing for different scenarios using a static placement of a relay link.

FIG. 5 illustrates a dynamic placement of a relay link.

FIG. 6 illustrates an embodiment of a method that uses dynamic placement of a relay link.

FIG. 7 illustrates an embodiment of a method that uses dynamic placement of a relay link and placing the SE in the central role on the relay link.

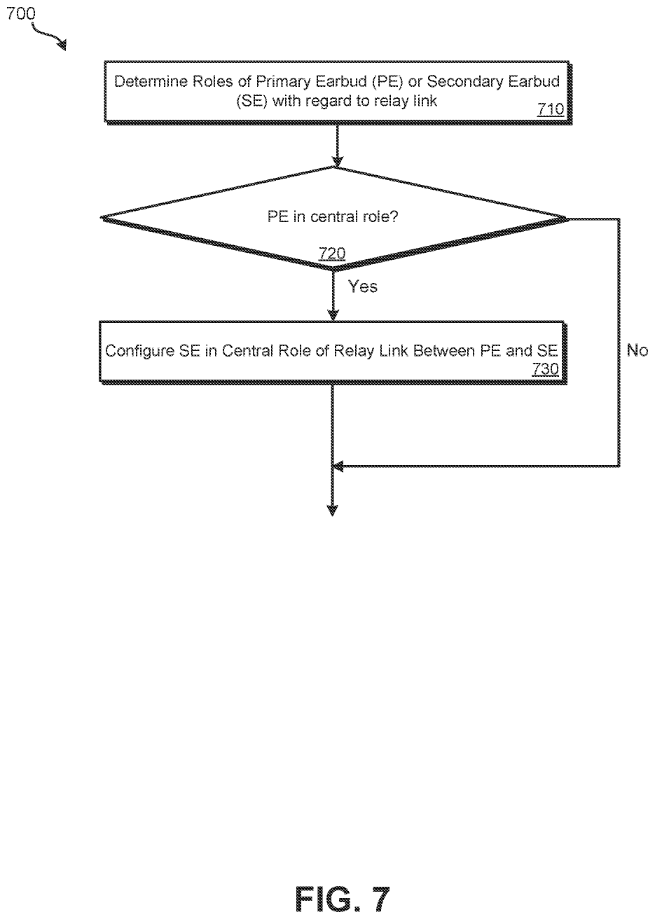

### DETAILED DESCRIPTION

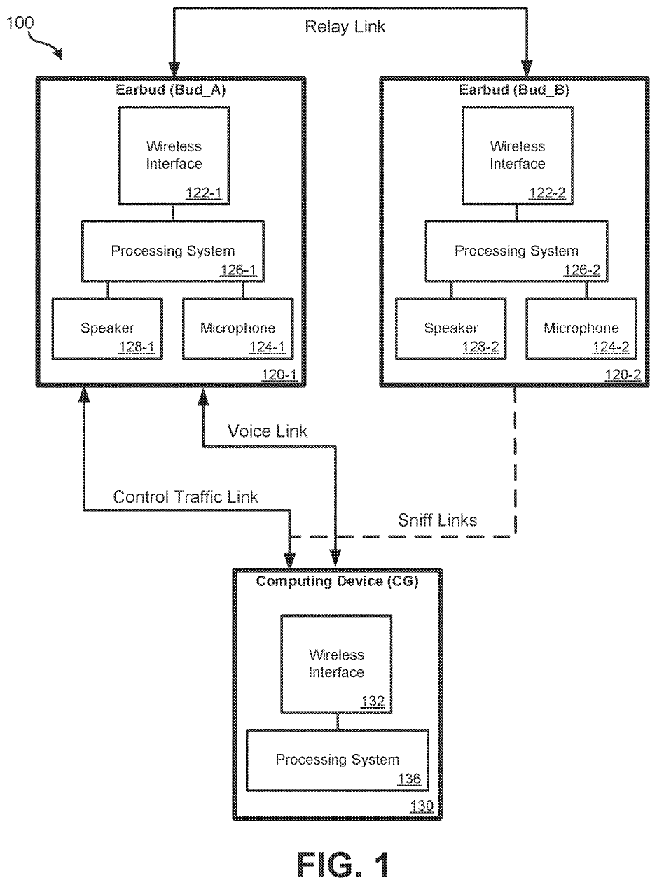

FIG. 1 illustrates a system 100 in which data is transmitted between earbuds 120, and a computing device 130 according to a dynamic placement mechanism. Downstream audio is transmitted from computing device 130 to earbuds 120 and upstream audio (e.g., voice captured via microphone) is transmitted from one of earbuds 120 to computing device 130. System 100 includes: earbud 120-1 (e.g., a right or left earbud of a pair of true wireless earbuds); earbud 120-2 (e.g., a true wireless earbud for the opposite ear from earbud 120-1); and computing device 130. The computing device 130 and the earbuds 120 are configured to support “audio use cases” such as telephony (cellular), Voice-Over-IP (VOIP) calls, media playback (e.g., music, game notifications, . . . ), and the like, using a wireless technology, such as but not limited to Bluetooth Classic (BR/EDR) technology and Bluetooth Low Energy (BLE) technology.

Earbuds 120 can be true wireless earbuds, which refer to a pair of earbuds that do not have any physical connection, such as a wire or band, connecting the two earbuds or with an audio source. True wireless earbuds can allow a user to use both earbuds 120 or use a single earbud (either earbud 120-1 or earbud 120-2) at a given time.

Some components of earbuds 120 are illustrated. Specifically, earbuds 120 include: wireless interfaces 122; microphones 124; processing systems 126; and speakers 128. All components of earbuds 120 can be housed by housings of the respective earbud, which can be made from a rigid or semi-rigid material. Earbuds 120 can be shaped to be at least partially inserted into a user's ear so that it will stay in place during normal body movements.

Wireless interface 122 can be a short-range wireless interface that allows for a device-to-device exchange of data. For example, short-range refers to a distance of up to 1, 10, 15, or 20 meters. Wireless interface 122 can be a Bluetooth interface that allows for data to be exchanged according to a communication protocol from the Bluetooth family of communication protocols, such as Bluetooth basic rate or extended data rate (BR/EDR, which can also be referred to as “Bluetooth Classic”), Bluetooth Low Energy (BLE), and/or Bluetooth LE audio. Wireless interface 122 can communicate using the 2.4 GHz band, which for Bluetooth spans from 2.4 GHz to 2.4835 GHz. This frequency band can be divided up into a number of channels, such as 80 channels for Bluetooth BDR/EDR, each 1 MHz wide, or 40 channels for Bluetooth LE or LE Audio, which are each 2 MHz wide. Bluetooth communications can involve frequent channel changes within the 2.4 GHz band, such as up to 1600 channel changes per second.

Wireless interfaces 122 can be understood as Bluetooth wireless interfaces in that each of wireless interfaces 122 can communicate with other Bluetooth interfaces (e.g., wireless interface 132) that conform to the Bluetooth standard. For example, in FIG. 1, audio source 130 has a Bluetooth interface, referred to as wireless interface 132. Wireless interfaces 122 can exchange data using Bluetooth LE with wireless interface 132. For example, wireless interface 132 may be used to transmit downstream audio packets to wireless interfaces 122 while upstream audio packets constructed using audio captured using one or more of microphones 124 are transmitted by wireless interfaces 122 to wireless interface 132.

In earbud 120-1, processing system 126-1 can be in communication with wireless interface 122-1; speaker 128-1; and microphone 124-1. In earbud 120-2, processing system 126-2 can be in communication with wireless interface 122-2; speaker 128-2; and microphone 124-2. Processing systems 126 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as flash memory or other forms of memory.

Speakers 128 are used for outputting audio to a user. Processing system 126 can control the volume of audio received via wireless interfaces 122. Microphones 124 are present in each of earbuds 120. Microphones 124 can be used to capture audio in the vicinity of earbuds 120, such as speech of a user wearing at least one of earbuds 120 and transmit the captured audio as upstream audio packets via Bluetooth (e.g., Bluetooth LE Audio) to computing device 130. Microphones 124 can also be used to capture audio to perform noise cancellation.

A particular earbud of earbuds 120 may be designated as a “primary” earbud (PE) and the other earbud is designated as a second earbud (SE). In some examples, both the PE and the SE establish a control link and audio link with the computing device 130. In other examples, the PE, such as earbud 120-1 establishes a control link and an audio link with the computing device 130 while the SE, such as earbud 120-2, passively sniffs the audio link and the control link (as illustrated by the dashed line) between the PE and the computing device 130.

A single earbud, or two or more earbuds, may capture and stream upstream audio to computing device 130. Earbuds 120 may decide among themselves which earbud is to transmit upstream audio. For instance, the decision as to which earbud is to transmit upstream audio may be based on battery charge in each earbud, signal strength between each earbud and computing device 130, and/or an amount of noise detected by each earbud on captured audio. In some embodiments, the audio captured by each of microphones 124 is combined together to create an upstream audio stream that is transmitted to computing device 130.

An earbud manufacturer is not in control of the fundamental experience. Earbud manufacturers rely on the source's selection of microphone channel rather than the earbud's (and thus earbud manufacturer's) selection. Some phone manufacturers may decide to combine the microphone audio from both earbuds; others may choose to use only the left; yet others may choose the opposite; and others may choose to switch periodically based upon some algorithm that the earbud manufacturer had no way to determine.

In a first arrangement, a left (“L”) earbud and a right (“R”) earbud decide between themselves which one will be the PE and which earbud will be the SE. In both arrangements, one earbud can optionally sniff data sent/received by the other earbud. Sniffing is defined as capturing the data wirelessly transmitted that is intended for a device other than the one doing the sniffing. Combining the microphone data sent by another earbud with a given earbud's microphone can be useful for a multitude of purposes, amongst which are beamforming of sound capture, wind/ambient noise reduction, increasing SNR of sound capture, finding direction of an auditory stimulus around the user, etc. The arrangements detailed herein can also be applied to loudspeakers.

Computing device 130 includes wireless interface 132 and processing system 136. Examples of computing device 130 can include: a smartphone; a desktop, laptop, or tablet computer; a gaming device; a smart television; a digital music player device; a smartwatch; smart glasses; an augmented reality or a virtual reality headset; or any other device from which a user may desire to stream audio to earbuds 120 and, possibly, transmit upstream audio from earbuds 120 to computing device 130. Computing device 130 includes wireless interface 132, which can communicate with earbuds 120, and other devices, such as HID device 140, using device-to-device communication protocols, such as a Bluetooth communication protocol (e.g., Bluetooth classic, Bluetooth LE, or Bluetooth LE Audio). Therefore, computing device 130 can transmit a downstream audio stream to one or more of earbuds 120 via wireless interface 132, receive an upstream audio stream from one or more of earbuds 120, and also communicate with one or more other Bluetooth devices.

Processing system 136 may include one or more special-purpose or general-purpose processors. Such special-purpose processors may include processors that are specifically designed to perform the functions of the components detailed herein, such as detailed in relation to processing systems 126.

The earbuds 120 may be configured to support telephony (cellular) voice call, Voice-Over-IP (VOIP) call, and media playback (music, game, notifications, etc.) use cases using both Bluetooth classic and BLE technologies. When using Bluetooth classic, the audio link uses an eSCO connection and the control link uses an ACL connection. When using BLE, the audio link uses a CIS connection, and the control link uses an ACL connection.

The eSCO connection associated with Bluetooth and the CIS connection associated with BLE both reserve bandwidth per the use case Quality of Service (QOS) requirements at the connection setup time. This reserved bandwidth is static and does not change for the lifetime of the connection. The actual utilized bandwidth, however, depends on the prevalent link conditions (environment, range, etc.). Therefore, the utilized bandwidth may change throughout the lifetime of the connection. For example, it is possible that 100% of the reserved bandwidth is used at some times, while at other times, some other percentage (e.g., 10%, 20%, 50%, . . . ) of the reserved bandwidth is used at other times.

As illustrated in FIG. 1, the earbuds 120 are configured to use a relay link to transfer data between earbud 120-1 and earbud 120-2. In some examples, the relay link can be used to forward one or more voice/audio packets from one earbud to another earbud. For instance, in the case when one earbud does not receive a packet, the relay link can be used to forward the packet from the earbud that received the packet to the earbud that did not receive the packet from the computing device.

In contrast to the audio link that has a reserved bandwidth, the relay link does not have reserved bandwidth. The utilized bandwidth for the relay link depends on different factors including if the voice/audio packet needs to be forwarded, and the prevalent link conditions (environment, person's body absorption of radio waves, etc.). Generally, if the link conditions are good then there may not be any need to retransmit a packet, but if the link conditions are poor then a packet may need to be retransmitted.

Accordingly, the reserved and utilized bandwidth for the audio use cases is a function of the reserved and utilized bandwidth of the eSCO or CIS connection used for the voice and the utilized bandwidth of the relay link. As the earbud may perform other activities (for example, scans to connect to other devices, multipoint connection to maintain connection with other devices, virtual assistant, . . . ) concurrently with the audio use cases, optimization of the bandwidth usage of the audio use cases can improve the performance and user experience for the audio and concurrently running activities.

According to techniques described herein, the Bluetooth bandwidth used by the earbuds 120 for relay traffic between the earbuds is directed at being optimized for the audio use cases by using a dynamic placement scheme and configuring the SE to be in the central role on the relay link between the earbuds. In the dynamic placement scheme, instead of reserving a predetermined number of slots for the voice traffic before a predetermined number of slots for the relay traffic, the relay traffic can be dynamically placed/moved after the voice traffic ends if voice traffic doesn't use all the reserved bandwidth and hence, some of the voice traffic's reserved bandwidth could be used for the relay traffic.

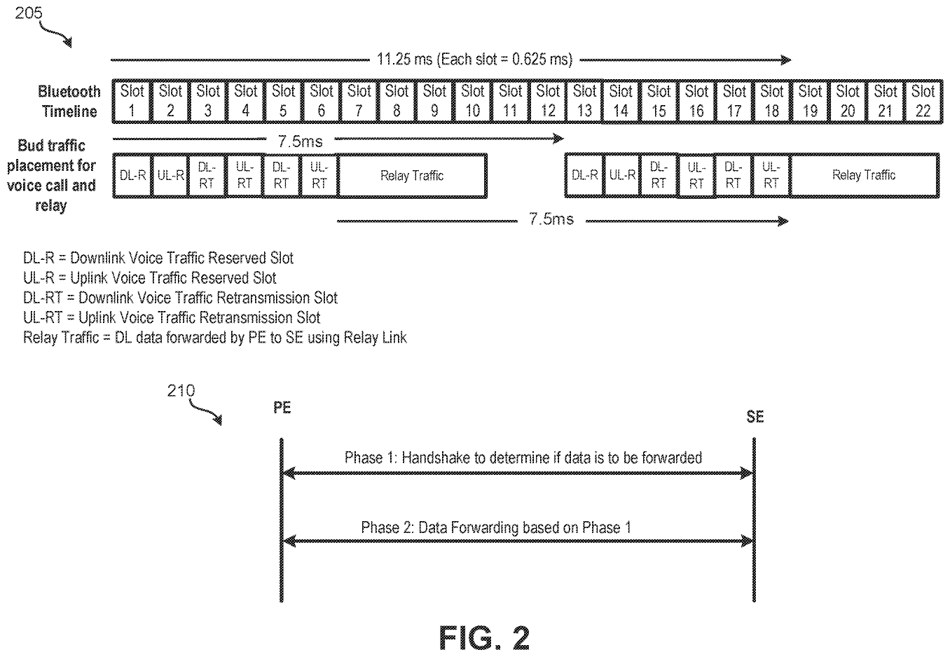

FIG. 2 illustrates a static placement of a relay link used to transfer relay traffic. In a static placement, the voice traffic has a predetermined number of slots used for voice traffic followed by a predetermined number of slots used for relay traffic. Example 205 illustrates twenty-two slots, with six slots (slots 1-6) reserved for downlink (DL) voice traffic, uplink (UL) voice traffic, DL voice traffic retransmission, and UL voice traffic retransmission. After the reserved UL and DL traffic, six slots are illustrated as reserved for data communication between the Bluetooth devices (e.g., between the PE and the SE) using the relay link. In many cases, however, six slots reserved for DL and UL voice traffic may not be used for voice traffic and retransmission. Instead, fewer slots may be used. As will be discussed in more detail below, instead of reserving a predetermined number of slots (e.g., slots 1-6) for the voice traffic before a predetermined number of slots (e.g., slots 7-12) for the relay traffic, the relay traffic can be dynamically placed/moved after the voice traffic ends if voice traffic doesn't use all the reserved bandwidth (e.g., the six slots in this example) and hence, some of the voice traffic's reserved bandwidth could be used for the relay traffic.

Also shown in FIG. 2 is a relay protocol 210 that illustrates a two-phase process that determines whether to forward data (e.g., an audio packet) from the PE to the SE using the relay link. Phase-1 is a handshake between the PE and SE that is used to determine if the SE requires data to be forwarded from the PE. When the SE indicates that the data is to be forwarded, phase-2 indicates that the PE forwards the data to the SE. In the current example, the SE requests a packet to be forwarded by the PE by setting a bit within a data packet indicating a request for the packet to be forwarded.

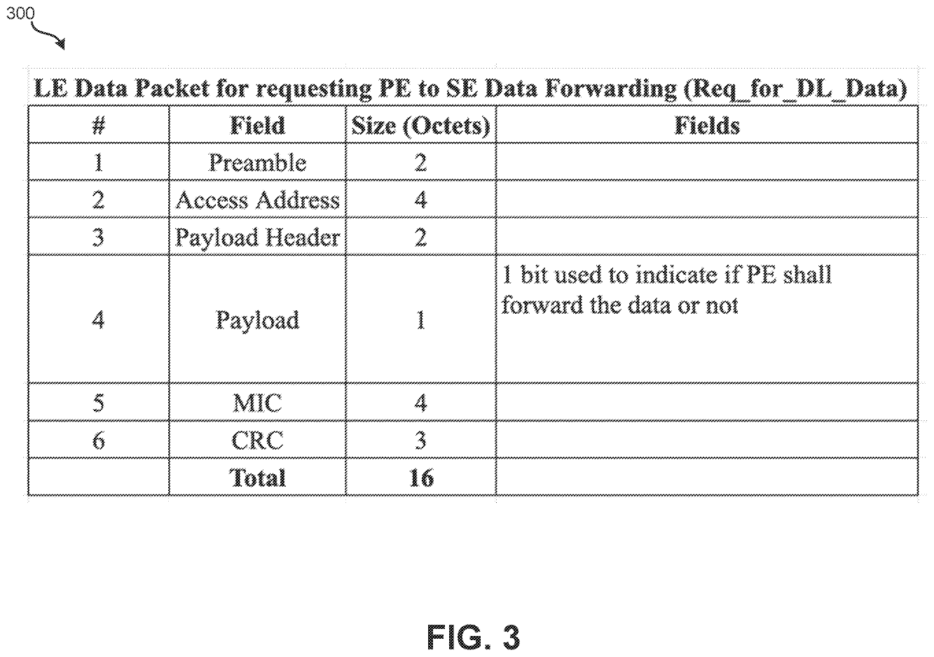

FIG. 3 shows the bits of an exemplary packet 300 that can be used by the SE to request a packet to be forwarded by the PE. As illustrated in FIG. 3, the data packet 300 can include different fields, including a payload field that can include one or more bits to indicate whether the SE is requesting data to be forwarded by the PE or not. Additional bits can also be included within the payload field for other users, such as requesting how much of the last data to forward, and the like. While a payload field is illustrated, other mechanisms can be used to indicate whether or not to forward data, such as some other field or indication.

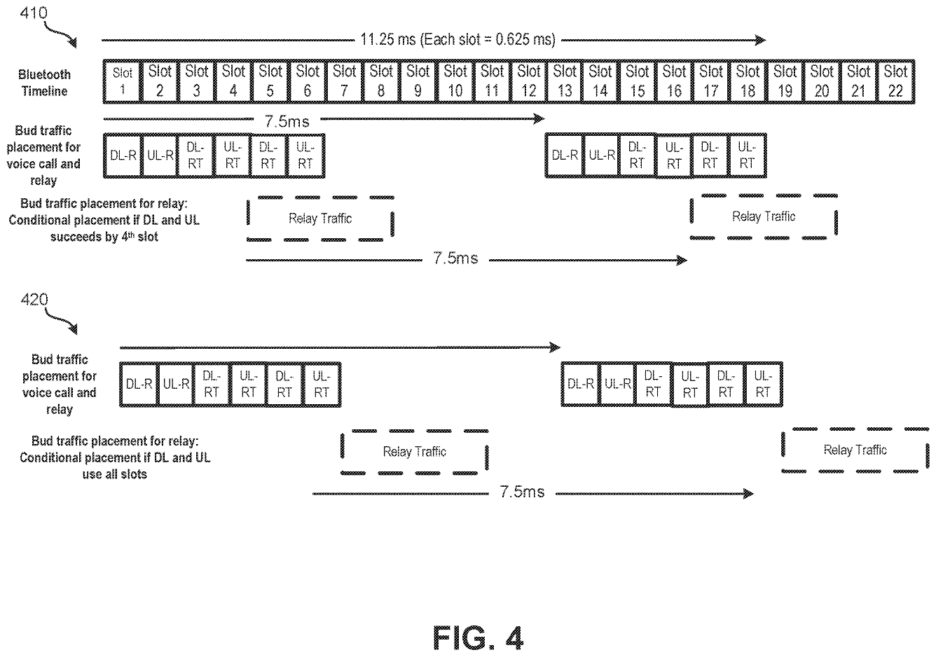

FIG. 4 illustrates a dynamic placement of a relay link. In a dynamic placement of the relay link, the voice traffic and retransmission traffic does not have a predetermined number of slots. Instead, relay traffic (if needed) may begin at an earlier slot (e.g., slot 3, 4, 5, 6 or 7) depending on if the slots are used.

Using dynamic placement of the relay link, the placement of the relay traffic may change in each interval as opposed to being a fixed placement as illustrated in FIG. 2 using the static placement scheme. According to some examples, the dynamic placement scheme technique checks the dynamic usage of the audio connection bandwidth in each interval. In other examples, the dynamic usage of the audio connection bandwidth may be checked at other times.

For instance, interval 410 illustrates starting the exchange of relay traffic at slot 5 when it is determined that voice traffic won't use slots five and six. For instance, the relay traffic may begin at slot 5 when there are no retransmissions needed for either the DL or UL, or when 1 retransmission is needed for DL but 0 retransmissions are needed for UL.

Interval 420 illustrates starting the exchange of relay traffic at slot 7 when six slots are used for the voice traffic. Using the dynamic placement of the relay link helps to increase the bandwidth that is available for communication. As illustrated, the use of the dynamic placement technique for the relay traffic can increase the number of consecutive free frames each interval.

When the reserved bandwidth is not completely used in a given interval, the dynamic placement technique releases the unused bandwidth for use by the relay link. This reduces the fragmentation of the free frames and hence, makes more contiguous free frames available for other concurrently running use cases. In contrast configuring the relay link between the earbuds 120 using an LE ACL connection as identified by the Bluetooth Special Interest Group (SIG) that specifies a static placement scheme in which the ACL connection's anchor point occurs at every connection interval duration, the connection interval can be dynamic.

According to some configurations, the SE is configured to be in the central role for the relay link between the PE and the SE. Stated another way, when the SE is in the central role, the SE requests data to be retransmitted from the PE. Whether or not the PE or the SE is in the central role, however, the dynamic placement technique results in more contiguous frames and less fragmented frames as compared to the static placement technique illustrated in FIG. 2.

Configuring the SE to be in the central role on the relay link helps to optimize the bandwidth usage of the relay link. For example, the bandwidth usage for the eSCO use case is optimized such that the relay link uses only 1 frame (1.25 ms) even in the case when there is one retransmission on the relay link. This in turn optimizes the bandwidth usage by the audio use cases and hence, makes more bandwidth available for other concurrently running use cases.

As discussed briefly above, the earbuds may change PE and SE roles dynamically. This could be due to several reasons (e.g., one earbud running low on battery, one earbud experiencing poorer link quality with the audio host, . . . ). The Bluetooth SIG specified standard, however, does not specify to place the SE in the central role on the relay link after the PE/SE switch as described herein. According to some examples, upon a dynamic PE/SE switch, the SE is placed in the primary role on the relay link. Stated another way, the role switch described herein for the central role on the relay link is different from a PE and SE role switch. A PE and SE role switch pertains to switching the role of the earbuds to decide which bud communicates with the computing device 130 (e.g., an audio host) and which earbud does passive listening of the communication with the host. The role switch for the SE to be in the central role pertains to the role switch on the relay link (LE ACL link) to ensure that SE remains Central on the relay link which helps with bandwidth optimizations.

The dynamic placement scheme and configuring the SE to be in the central role on the relay link helps to optimize the bandwidth used by the audio use cases and also reduces the fragmentation of free frames. This results in more contiguous free frames availability and hence, improves the performance of other concurrently running use cases while ensuring good audio quality for the audio use cases.

The techniques described herein help improve the overall user experience provided by the earbuds as the techniques help to ensure good audio quality along with improved concurrency with other concurrently running use cases (for example, scans, multipoint, voice assistant(s), . . . ). As an example, the user experience may be improved using the techniques such as when earbuds are simultaneously connected with a phone, tablet, or some other computing device while also engaged in different activities (e.g., music playback and a voice assistant).

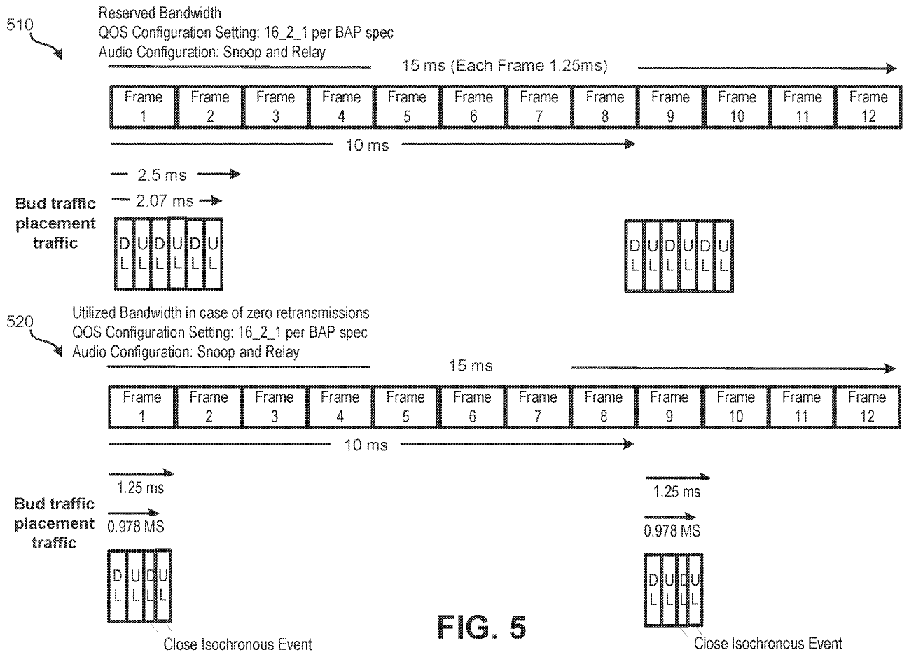

FIG. 5 illustrates using dynamic placement of a relay link and placing the SE in the central role on the relay link. The concept for CIS connection use cases is similar as the eSCO connection use cases. As mentioned above, the eSCO and CIS connections are similar in nature and therefore can benefit from the dynamic placement technique and placing the SE in the central role described above.

For purposes of explanation with regard to FIG. 5, assume the reserved and utilized bandwidth for QoS configuration 16_2_1 specified in Basic Audio Profile (BAP) specification for LE Audio: 32 Kbps codec bitrate (40 bytes codec frame every 10 ms); 10 ms CIS interval; and 2 retransmissions.

Using the static placement technique, as illustrated in interval 510, the relay traffic could begin at frame 3 with an interval of 10 ms. Using the dynamic placement technique, as illustrated in interval 520, the relay traffic could be conditionally either at frame 2 or frame 3 with the relay link connection interval of 10 ms. Accordingly, use of the dynamic placement technique along with placing the SE in the central role on the relay link can improve bandwidth usage and improved concurrency as shown in the eSCO case.

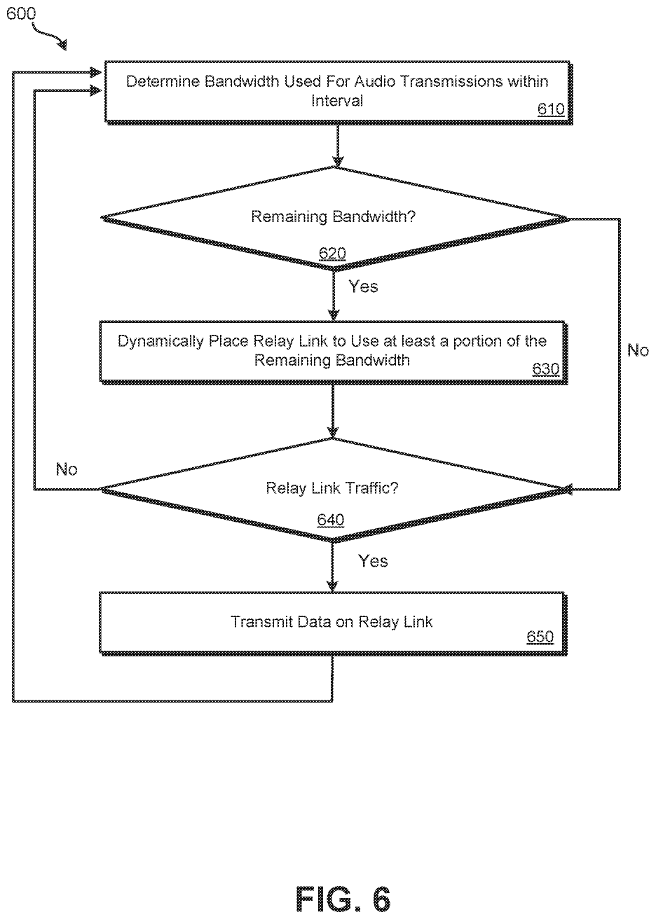

Various methods may be performed using the systems, states, and arrangements detailed in relation to FIGS. 1-5. FIG. 6 illustrates an embodiment of a method 600 that uses dynamic placement of a relay link. Method 600 refers to a “primary earbud” (PE), and a “secondary earbud” (SE). Either a left or right earbud can function as a PE and the other earbud functions as the SE.

At block 610, the bandwidth used for audio transmissions between an audio source (e.g., computing device 130) and a PE is determined. As discussed above, the bandwidth used may be all or a portion of the available bandwidth. In some examples, the PE 120 may be configured to perform the determination. In other examples, the SE 120 may be configured to perform the determination.

At block 620, a decision is made as to whether there is any remaining bandwidth of the reserved bandwidth. As discussed above, an audio transmission may not need to use the reserved slots (e.g., six slots as illustrated in FIG. 2) in the audio channel. For instance, two of the slots may remain after completion of the audio transmission. When there is remaining bandwidth, the method moves to block 630. When there is not any remaining bandwidth, the process moves to block 640.

At block 630, the relay link between the PE and the SE is dynamically placed. As discussed above, the relay link is an ACL link that is used to transfer the relay traffic between the earbuds 120.

At block 640, a decision is made as to whether there is any relay link traffic to transmit. As discussed above, there may or may not be data to transfer between the earbuds. For instance, the SE 120 may have received all of the data by sniffing the data from the link between the PE and the AH. In some examples, the SE sends a request to the PE to request data to be retransmitted using the relay link. In other examples, the PE may send a query to the SE that asks the SE if any data needs to be retransmitted. When there is not any relay link traffic to transmit, the method returns to block 610.

At block 650, the data is transmitted on the relay link. As discussed above, the PE may transmit the traffic to the SE over the relay link. As also discussed, either the left or the right earbud may be a PE or SE, and the PE and SE may change over time.

FIG. 6 illustrates an embodiment of a method 600 that uses dynamic placement of a relay link and placing the SE in the central role on the relay link. Method 600 refers to a “primary earbud” (PE), and a “secondary earbud” (SE). Either a left or right earbud can function as a PE and the other earbud functions as the SE.

At block 710, a determination is made as to what earbud 120 is configured as the PE or the SE. As discussed above, either the PE or the SE may be configured as the central role.

At block 720, a decision is made as to whether the PE is configured in the central role with regard to the relay link. When the PE is not in the central role the process 700 does not perform a configuration. When the PE is in the central role the process moves to block 730.

At block 730, the SE is configured as the central role in the relay link between the PE and the SE. As discussed above, the central role of the relay link is performed by the SE and not the PE.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for managing Bluetooth bandwidth, the method comprising:
establishing a Bluetooth audio connection between a first earbud and a computing device, wherein the Bluetooth audio connection is used by the first earbud to receive audio data for the first earbud and a second earbud;
establishing a relay link to transmit relay traffic between the first earbud and a second earbud, wherein the relay traffic includes at least a portion of the audio data received by the first earbud;
determining that reserved bandwidth associated with the Bluetooth audio connection remains available within an interval after a transmission of the audio data for the interval; and
using at least a portion of the reserved bandwidth to transmit, using the relay link, the at least the portion of the audio data received by the first earbud to the second earbud.

2. The method of claim 1, further comprising:
determining that the first earbud, designated as a primary earbud, is configured in a central role on the relay link; and
configuring the second earbud in the central role in place of the first earbud.

3. The method of claim 1, further comprising determining that the second earbud failed to receive the at least the portion of the audio data received by the first earbud over the Bluetooth audio connection during the interval.

4. The method of claim 3, wherein determining that the second earbud failed to receive the at least the portion of the audio data comprises receiving, at the first earbud, a request from the second earbud to transmit the at least the portion of the audio data.

5. The method of claim 4, wherein determining that the second earbud failed to receive the at least the portion of the audio data comprises sending a query from the first earbud to the second earbud associated with use of the relay link during the interval and receiving, at the first earbud, a response from the second earbud that indicates to use the relay link to retransmit the at least the portion of the audio data.

6. The method of claim 1, wherein the earbud and a second earbud are true wireless stereo earbuds.

7. The method of claim 1, wherein the Bluetooth audio connection is a Connected Isochronous Stream (CIS) connection with the computing device.

8. The method of claim 1, wherein the Bluetooth audio connection is an Enhanced Synchronous Connection Oriented (eSCO) connection.

9. A wireless earbud system that uses a Bluetooth Audio protocol, comprising:
a first earbud comprising: a first wireless interface, a first speaker, a first processing system, and a first microphone; and
a second earbud comprising: a second wireless interface, a second speaker, a second processing system, and a second microphone, wherein the first earbud is configured to:
establish a Bluetooth audio connection with a computing device, wherein the Bluetooth audio connection is used by the first earbud to receive audio data for the first earbud and the second earbud;
establish a relay link with the second earbud to transmit relay traffic, wherein the relay traffic includes at least a portion of the audio data received by the first earbud;
determine that reserved bandwidth associated with the Bluetooth audio connection remains available within an interval after a transmission of the audio data for the interval; and
use at least a portion of the reserved bandwidth to transmit, using the relay link, the at least the portion of the audio data received by the first earbud to the second earbud.

10. The wireless earbud system of claim 9, wherein the first earbud, configured as a primary earbud that is in a central role on the relay link, is further configured to cause the second earbud to be configured in the central role in place of the first earbud.

11. The wireless earbud system of claim 9, wherein the first earbud is further configured to determine that the second earbud failed to receive the at least the portion of the audio data received by the first earbud over the Bluetooth audio connection during the interval.

12. The wireless earbud system of claim 11, wherein determining that the second earbud failed to receive the at least the portion of the audio data comprises receiving, at the first earbud, a request from the second earbud to retransmit the at least the portion of the audio data.

13. The wireless earbud system of claim 12, wherein determining that the second earbud failed to receive the at least the portion of the audio data comprises sending a query from the first earbud to the second earbud associated with use of the relay link during the interval and receiving, at the first earbud, a response from the second earbud that indicates to use the relay link to transmit the at least the portion of the audio data.

14. The wireless earbud system of claim 9, wherein the first earbud and a second earbud are true wireless stereo earbuds.

15. The wireless earbud system of claim 9, wherein the Bluetooth audio connection is a Connected Isochronous Stream (CIS) connection with the computing device.

16. The wireless earbud system of claim 9, wherein the Bluetooth audio connection is an Enhanced Synchronous Connection Oriented (eSCO) connection.

17. A non-transitory computer-readable medium containing computer executable instructions that, when executed by a processor, cause the processor to perform a method, comprising:
establishing a Bluetooth audio connection between a first earbud and a computing device, wherein the Bluetooth audio connection is used by the first earbud to receive audio data for the first earbud and a second earbud;
establishing a relay link to transmit relay traffic between the first earbud and a second earbud, wherein the relay traffic includes at least a portion of the audio data received by the first earbud;
determining that reserved bandwidth associated with the Bluetooth audio connection remains available within an interval after a transmission of the audio data for the interval; and
using at least a portion of the reserved bandwidth to transmit, using the relay link, the at least the portion of the audio data received by the first earbud to the second earbud.

18. The non-transitory computer-readable medium of claim 17, wherein the computer executable instructions that, when executed by a processor, further cause the processor to:
determine that the first earbud, designated as a primary earbud, is configured in a central role on the relay link; and
configure the second earbud in the central role in place of the first earbud.

19. The non-transitory computer-readable medium of claim 17, further comprising determining that the second earbud failed to receive the at least the portion of the audio data received by the first earbud over the Bluetooth audio connection during the interval.

20. The non-transitory computer-readable medium of claim 17, wherein determining that the second earbud failed to receive the at least the portion of the audio data comprises receiving, at the first earbud, a request from the second earbud to retransmit the at least the portion of the audio data.
